(19) United States
(12) Patent Application Publication
(10) Pub. No.: US 2024/0179791 A1
(43) Pub. Date: May 30, 2024

(54) RRC STATE TRANSITION REPORTING

(71) Applicant: Nokia Technologies Oy, Espoo (FI)

(72) Inventors: Jussi-Pekka KOSKINEN, Oulu (FI); Samuli Heikki TURTINEN, Oulu (FI); Jorma Johannes KAIKKONEN, Oulu (FI); Chunli WU, Beijing (CN)

(21) Appl. No.: 18/259,741

(22) PCT Filed: Jan. 11, 2021
(86) PCT No.: PCT/CN2021/071136

§ 371 Date: Jun. 28, 2023

(51) Int. Cl. H04W 76/28; H04W 24/10; H04W 76/27

(52) U.S. Cl. CPC H04W 76/28; H04W 24/10; H04W 76/27

(57) ABSTRACT

Embodiments of the present disclosure relate to devices, methods, apparatuses and computer readable storage media of state transition reporting. The method comprises: determining, at a first device, a DRX configuration for a second device in an inactive state, the second device located within an area served by one or more devices comprising the first device; determining configuration information based at least in part on the DRX configuration; and transmitting, to a third device of a core network, the configuration information to cause the third device to adjust downlink transmissions for the second device. The core network can determine when the UE is reachable and adjust transmissions associated with paging accordingly. As such, a longer eDRX cycle can be achieved without increasing buffering burden at the RAN.

### FIELD

Embodiments of the present disclosure generally relate to the field of telecommunication and in particular, to methods, devices, apparatuses and computer readable storage media for radio resource control (RRC) state transition reporting.

### BACKGROUND

In a legacy communication network, for example, in LTE system, a terminal device (e.g., UE) may utilize an extended discontinuous reception (eDRX) in a RRC idle state. During a paging transmission window (PTW) of each eDRX cycle, the UE monitors a paging channel for paging message including the UE's identity. Since a mobility management entity (MME) at the core network (CN) side is aware of the eDRX configuration of the UE, for example, a paging hyperframe (PH) number and the beginning of the PTW, the MME can transmit a paging request to a base station (e.g., eNB) of the radio access network (RAN) just before the beginning of the PTW or during the PTW, and thus the eNB may prevent from storing paging messages as well as excessive data transmission.

As communication technologies evolve to the fifth generation (5G) new radio (NR), a RRC inactive state has been introduced. A UE in the RRC inactive state may operate in a state the UE can utilize the eDRX while move in a RAN-based notification area (RNA) without notifying the RAN. The RNA may cover more than one cell provided by a plurality of base stations (e.g., gNBs), which include an anchor gNB that communicates with the access and mobility management function (AMF) at the CN and may perform a RRC connection resume procedure with the UE, and the last gNB that serves the UE may remain the UE context data. When the last serving gNB receives downlink (DL) data or DL transmissions from the AMF, the anchor gNB broadcasts the paging message in all the cells of the RNA. The RAN node may notify the AMF of a state transition related to the inactive state, that is, the UE enters or leaves the inactive state, by means of a RRC inactive transition reporting procedure. From the perspective of CN, limited knowledges about eDRX configurations of the UE can be deduced from the RRC inactive transition report.

### SUMMARY

In general, example embodiments of the present disclosure provide a solution for RRC state transition reporting.

In a first aspect, there is provided a first device. The first device comprises at least one processor; and at least one memory including computer program code; the at least one memory and the computer program code are configured to, with the at least one processor, cause the first device to: determine an extended discontinuous reception configuration for a second device in an inactive state, the second device located within an area served by one or more devices comprising the first device; determine configuration information based at least in part on the extended discontinuous reception configuration; and transmit, to a third device of a core network, the configuration information to cause the third device to adjust downlink transmissions for the second device.

In a second aspect, there is provided a third device. The second device comprises at least one processor; and at least one memory including computer program code, the at least one memory and the computer program code are configured to, with the at least one processor, cause the third device to: receive, from a first device of an access network, configuration information, the configuration information determined based on an extended discontinuous reception configuration for a second device in an inactive state, and the second device located within an area served by one or more devices comprising the first device; and adjust downlink transmissions for the second device based on the configuration information.

In a third aspect, there is provided a method. The method comprises: determining, at a first device, an extended discontinuous reception configuration for a second device in an inactive state, the second device located within an area served by one or more devices comprising the first device; determining configuration information based at least in part on the extended discontinuous reception configuration; and transmitting, to a third device of a core network, the configuration information to cause the third device to adjust downlink transmissions for the second device.

In a fourth aspect, there is provided a method. The method comprises: receiving, at a third device and from a first device of an access network, configuration information, the configuration information determined based on an extended discontinuous reception configuration for a second device in an inactive state, and the second device located within an area served by one or more devices comprising the first device; and adjusting downlink transmissions for the second device based on the configuration information.

In a fifth aspect, there is provided a first apparatus. The first apparatus comprises: means for determining, at a first apparatus, an extended discontinuous reception configuration for a second apparatus in an inactive state, the second apparatus located within an area served by one or more devices comprising the first apparatus; means for determining configuration information based at least in part on the extended discontinuous reception configuration; and means for transmitting, to a third apparatus of a core network, the configuration information to cause the third apparatus to adjust downlink transmissions for the second apparatus.

In a sixth aspect, there is provided a second apparatus. The second apparatus comprises: means for receiving, at a third apparatus and from a first apparatus of an access network, configuration information, the configuration information determined based on an extended discontinuous reception configuration for a second apparatus in an inactive state, and the second apparatus located within an area served by one or more devices comprising the first apparatus; and means for adjusting downlink transmissions for the second apparatus based on the configuration information.

In a seventh aspect, there is provided a non-transitory computer readable medium comprising program instructions for causing an apparatus to perform at least the method according to the above third aspect.

In an eighth aspect, there is provided a non-transitory computer readable medium comprising program instructions for causing an apparatus to perform at least the method according to the above fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which embodiments of the present disclosure may be implemented;

FIG. 2 illustrates a signaling flow for a state transition reporting related to the RRC inactive state in accordance with some example embodiments of the present disclosure;

FIG. 3 illustrates a flowchart of a method implemented at a first device in accordance with some example embodiments of the present disclosure;

FIG. 4 illustrates a flowchart of a method implemented at a second device in accordance with some example embodiments of the present disclosure;

FIG. 5 illustrates a simplified block diagram of an apparatus that is suitable for implementing embodiments of the present disclosure; and

FIG. 6 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IOT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems, including but not limited to a terrestrial communication system, a non-terrestrial communication system or a combination thereof. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

In the LTE system, the MME knows when the UE operates in the eDRX mode in RRX idle state. The eDRX cycle is up to 10.24s, and in some cases, the eDRX cycle is even extended to 2621. 44s. The hyper system frame number (H-SFN) is broadcast by the RAN node in the cell and increments by one when the SFN wraps around. The PH refers to the H-SFN in which the UE starts to monitor paging message during a PTW used in ECM-IDLE. The PH may be determined based on a rule that is known by the MME/AMF, UE and the RAN node as a function of the eDRX cycle and the UE identity. The UE may monitor paging messages during the PTW configured by NAS, or until a paging message including the UE's NAS identity is received by the UE. The possible starting offsets for the PTW are uniformly distributed within the PH. By using the rule to determine the PH as well as the beginning of the PTW, the MME/AMF is able to transmit a S1 paging request just before the occurrence of the start of PTW or during PTW, and thus the eNB may prevent from storing paging messages as well as excessive data transmission.

The UE complexity reduction, as one of the key features for NB-IOT in 5G NR. may involve reduced number of UE reception (RX)/transmission (TX) antennas, UE bandwidth reduction, half-duplex frequency division duplexing (FDD), relaxed UE processing time and capability and the like, which also put forward requirements of UE's power consumption. To balance the power consumption and the traffic delay, the UE may enter in the RRC inactive state in which the UE uses the eDRX mode. For RRC inactive state, the eDRX cycle is extended to be 10485.76s.

The RAN node may notify the AMF when the UE enters or leaves the RRC inactive state via the RRC inactive transition reporting procedure. The RAN node may initiate the procedure by transmitting, for example, an RRC INACTIVE TRANSITION REPORT message to the AMF. Upon reception of the RRC INACTIVE TRANSITION REPORT message, the AMF takes appropriate actions based on the information indicated by the RRC State IE. Since RRC INACTIVE configuration is handled by RAN and due to its capabilities, the AMF cannot deduce the eDRX configurations of the UE from the RRC inactive transition report.

This challenges the data buffering at the RAN node, for example, the anchor node. The AMF may transmit paging requests as well as DL packets to the RAN node without knowledge of the eDRX cycle the UE applies. However, at this point of time, the RAN node cannot transmit those to the UE, because the RAN node needs to page the UE first and then the DL packets can be forwarded at a next active occasion of the eDRX cycle, which may occur a long time later in the future. In addition, NAS retransmission timers are rather short, such as, 10s or so and therefore the eDRX cycle cannot be longer than the NAS retransmission timers.

In order to solve the above and other potential problems, embodiments of the present disclosure provide a flexible state transition reporting of information about eDRX configurations. In general, in determining that the UE goes through a state transition, which includes a first transition from the RRC connected state to the RRC inactive state and a second transition from the RRC inactive state to the RRC connected state, the RAN node may provide sufficient information related to the state transition via the state transition reporting procedure to the CN node. By this way, the CN node may determine when the UE is reachable based on the information related to the state transition and adjust the transmission of the paging request as well as DL transmissions accordingly. As such, the buffering burden at the RAN node can be alleviated, and longer eDRX cycles can be used.

Example embodiments of the present disclosure will be described in detail below with reference to the accompanying drawings. Principle and embodiments of the present disclosure will be described in detail below with reference to the accompanying drawings.

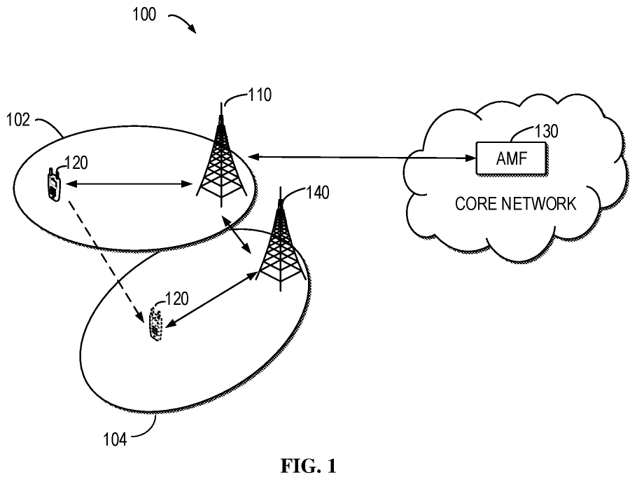

FIG. 1 illustrates an example communication environment 100 in which embodiments of the present disclosure may be implemented. The communication environment 100 includes a first device 110, a second device 120, a third device 130 as well as a fourth device 140.

The first device 110 and the fourth device 140 may be network devices in the RAN, for example, base stations, and provide cells 102 and 104, respectively. In some example embodiments, the overall coverage of the cells 102 and 104 may be referred to as the RNA or paging area. In the context of the example embodiments, the first device 110 may act as an anchor network device or anchor node, and the fourth device 140 may act as the last node serving the second device 120. As discussed above, the anchor node (i.e., the first device 110) may communicate with the access and mobility management function (AMF) at the CN and perform the RRC connection resume procedure with the second device 120, while the last node (i.e., the fourth device 140) may maintain the context data of the second device 120.

The first device 110 may configure the eDRX configurations with the second device 120. The eDRX configurations may include, but not limited to, the eDRX cycle, the H-SFN including the PTW and PH, the On-duration timer, the inactivity timer, the DRX start offset, the DRX retransmission timer and so on. With the eDRX configurations, the second device 120 may determine when to enter the RRC inactive state and when to monitor the paging channel, which will be described in details below.

The second device 120 may be a terminal device located within the RNA. For example, the second device 120 may move within the coverage of the RAN. As shown in FIG. 1, the second device 120 initially is served by the first device 110, and then served by the fourth device 140. In the example embodiments, the second device 120 may switch between different states and hence go through state transition which includes the first transition from the RRC connected state to the RRC inactive state and the second transition from the RRC inactive state to the RRC connected state.

In the RRC inactive state, the second device 120 may monitor the paging channel for paging messages during the PTW on a H-SFN configured by the first device 110. Specifically, the PTW may include a set of paging occasions (PO), and the second device 120 monitors the paging channel on each of the POs. Upon receipt of the paging message including the second device 120's NAS identity, the second device 120 may then establish the RRC connection to receive the DL data transmission.

The third device 130 may be a CN node that is in charge of access and mobility management. The third device 130 may communicate with the anchor node of the RNA, i.e., the first device 110. For example, the third device 130 may transmit a paging request and possible DL data or transmissions to the first device 110. Upon receipt of the paging request and the possible DL transmissions, the first device 110 may then perform paging within the RNA and then forward the possible DL data or transmissions to the corresponding second device 120. Only for case of discussion, the third device 130 is illustrated as the AMF in FIG. 1, and any other devices or nodes for implementing similar functions are also suitable for the embodiments of the present disclosure.

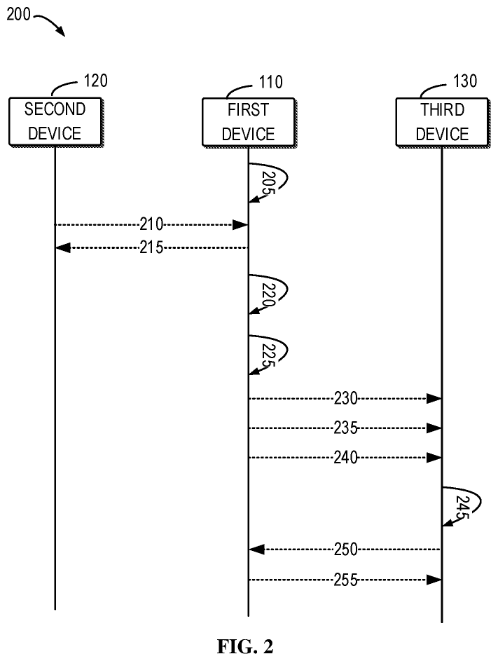

In a case where the second device 120 is to perform a state transition related to the inactive state, the third device 130 may receive, from the first device 110, a state transition report that indicates whether the first transition or the second transition is to be performed. In the above case and in a case where the second device 120 is in an extended discontinuous reception mode, the third device 130 may further receive configuration information from the first device 110. With the configuration information, the third device 130 may determine the second device 120's reachability and adjust the transmission of the paging request as well as DL transmissions accordingly, which will be discussed in connection with FIGS. 2 to 4 below.

It is to be understood that the number of network devices, terminal devices and/or cells is given for the purpose of illustration without suggesting any limitations to the present disclosure. The communication environment 100 may include any suitable number of network devices, terminal devices and/or cells adapted for implementing implementations of the present disclosure. Although not shown, it would be appreciated that one or more additional devices may be located in the cells 102 and 104, and one or more additional cells may be deployed in the environment 100.

Only for ease of discussion, the first device 110 and the fourth device 140 are illustrated as base stations and the second device 120 is illustrated as a UE. It is to be understood that base station and UE are only example implementations of the first device 110, the fourth device 140 and the second device 120, respectively, without suggesting any limitation as to the scope of the present application. Any other suitable implementations are possible as well.

Communications in the communication network 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

To better understand the state transition reporting procedure proposed in the disclosure, reference is now made to FIG. 2, which illustrates a signaling flow 200 for RRC inactive transition reporting in accordance with some example embodiments of the present disclosure. The signaling flow 200 may involve the first device 110, the second device 120 and the third device 130 as illustrated in FIG. 1. For the purpose of discussion, the signaling flow 200 will be described with reference to FIG. 1.

In the signaling flow 200, the first device 110 determines 205 that the second device 120 is in the eDRX mode or a state transition related to the inactive state is to be performed at the second device 120. As used herein, the state transition related to the inactive state refers to one of the first transition from the RRC connected state to the RRC inactive state and the second transition from the RRC inactive state to the RRC connected state.

By way of example, in a case of the second transition, the second device 120 may initiate a RRC connection Resume procedure by transmitting 210 a RRC connection resume request to the anchor node, i.e., the first device 110. The RRC connection resume request may include the I-RNTI assigned by the last RAN node that serves the second device 120, i.e., the fourth device 140.

In the above case, the first device 110 may obtain the data context of the second device 120 from the fourth device 140. Then, the first device 110 may perform 215 the RRC connection Resume procedure and the second transition is completed.

In the case where the first device 110 determines that the state transition is to be performed, the first device 110 determines 220 an eDRX configuration for the second device 120 in the inactive state. For example, the eDRX configuration may include, but not limited to, a duration of the eDRX cycle, the PTW, paging hyperframe number, the H-SFN information configured for the second device 120.

The first device 110 determines 225 configuration information based at least in part on the eDRX configuration. The configuration information may include, for example, one or more of the duration of eDRX cycle, the PTW, a paging hyperframe number of the second device 120, the H-SFN, a buffer status of the first device 110, possible DL transmission occasions and a delay duration for the DL transmissions for the third device 130, and so on.

In some example embodiments, the eDRX configuration may include a duration of the eDRX cycle for the second device 120. In this case, the first device 110 may determine whether the duration of the eDRX cycle exceeds a duration threshold, which is a configurable parameter or specified by the mobile network operator. If the duration of the eDRX cycle exceeds the duration threshold, it may indicate that the second device 120 may not frequently receive DL transmissions. Additionally or alternatively, it may undesirable for the first device 110 to buffer too many DL transmissions to be forwarded to the second device 120. In this case, the first device 110 may determine the configuration information based on the duration of the eDRX cycle, and the configuration information may be transmitted to third device 130 for indicating this fact.

Otherwise, if the duration of the eDRX cycle does not exceed the duration threshold, it may indicate that there is no need to inform the third device 130 of the state transition related to the inactive state. In this case, the first device 110 may not determine and transmit the configuration information to the third device 130.

In some example embodiments, the first device 110 may determine the configuration information based on the eDRX configuration and a duration of a retransmission timer of the third device 130. By way of example, if a next PO of the eDRX cycle arrives after the retransmission timer of the third device 130 expires, it may result in excessive data transmissions buffered at the first device 110. In this case, the first device 110 may determine the configuration information to cause the third device to increase the duration of the retransmission timer. In some examples, the retransmission timer may be a NAS retransmission timer.

In some example embodiments, the first device 110 may determine the configuration information based on the eDRX configuration and a buffer status of the first device 110. By way of example, if the first device 110 determines that the buffer of the first device 110 is to be filled with DL transmissions from the third device 110 based on the duration of eDRX cycle and the buffer status of the first device 110, the first device 110 may determine the configuration information indicative of the maximum buffer size of the first device 110 or alternatively a size threshold for DL transmissions. With such configuration information, the third device 130 may determine a size of DL transmissions to be allowed.

Upon determination of the configuration information, the first device 110 transmits 230 to the third device 130 to cause the third device 130 to adjust DL transmissions for the second device 120. The configuration information may be transmitted via a RRC inactive transition report message. It should be understood that any other message or signal is also possible for transmission of the configuration information, and thus the scope of the present disclosure is not limited in this regard.

In the above case where the duration of the eDRX cycle exceeds the duration threshold, it may indicate that there is a need for the third device 130 to adjust the DL transmissions to be forwarded to the second device 120, for example, by increasing a duration of a retransmission timer of the third device 130. The first device 110 may cause to the third device 130 to increase the duration of the retransmission timer in an implicit manner or an explicit manner.

As an example of the implicit manner, upon receipt of the configuration information, for example, indicative of the duration of the eDRX cycle, the third device 130 may determine a new duration of the retransmission timer based on the duration of the eDRX cycle. As a result, the retransmission of DL data may be reduced or avoided until the next PO arrives.

The first device 110 may further provide the third device 130 with additional information or indications in a dynamic and flexible manner. As an example of the explicit manner, the first device 110 may transmit 230 an indication of a possible delay of the retransmission timer to the third device 130. Alternatively, the first device 110 may transmit 230 an indication of a suggested new duration of the retransmission timer.

In some example embodiments, the first device 130 may determine whether the DL transmissions from the third device 130 are allowed based on the eDRX cycle of the second device 120. If the DL transmissions are allowed, the first device 110 may transmit 235 a first indication of the DL transmissions being allowed to the third device 130. Otherwise, if the DL transmissions are not allowed, the first device 110 may transmit 240 a second indication of no DL transmission being allowed to the third device 130.

In some example embodiments, the second device 120 may transmit UL transmissions to the first device 110, which may implicitly indicates that the second device 120 is also able to receive the DL transmissions. In this case, the first device 110 may determine that the DL transmissions may also be allowed, and transmit the first indication to the third device 130.

Additionally or alternatively, upon receipt of the UL transmissions, the User Plane Function (UPF) in the core network may determine that the DL transmissions are also allowed. In this case, the UPF may transmit the first indication to the third device 130. In some examples, in this case, the first device 110 may not transmit the first indication to the third device 130.

Upon receipt of the configuration information and selectively the additional information and indications, the third device 130 adjust 245 the DL transmissions for the second device 120 accordingly.

The third device 130 may then transmit 250 the DL transmissions to the first device 110, for example, in response to receipt of the first indication from the first device 110. The DL transmissions may include at least one of a paging request, data transmissions or data retransmissions. In some example embodiments, the third device 130 may determine a reachability of the second device 120 based on the eDRX configuration, and thus the subsequent DL transmissions can be transmitted based on the reachability of the second device 120.

In some example embodiments, the configuration information may include DL transmission occasions for the third device 130. In this case, the third device 130 may transmit the DL transmissions on the DL transmission occasions.

In some example embodiments, the configuration information may include a buffer status of the first device 110. In this case, the third device 130 may determine a buffer size of the first device 110 based on the buffer status and transmit the DL transmissions of a first size below the buffer size.

In some example embodiments, the third device 130 may receive 255 an indication of the DL transmissions being dropped from the first device 110. In this case, the third device 130 may determine the DL transmissions are not allowed and stop further data transmissions for the second device 120.

It is to be understood that the example implementation is given for purpose of illustration without any limitation. For example, the configuration information as well as the additional information and indications as described in details above may be transmitted via a single signal or message, such as, the RRC inactive transition report message. It is also possible for such information and indications to be transmitted separately or part of the same may be transmitted via the RRC inactive transition report message while the rest part may be transmitted via another message or signal. The scope of the present disclosure is not limited in this regard.

The example embodiments of the present disclosure provide a flexible state transition reporting procedure. Once the state transition related to the RRC inactive state is determined to be performed, the RAN node, for example, the anchor gNB of the RNA can inform the AMF of the CN of this fact with configuration information and additional indications in a dynamic and flexible manner. As such, a longer eDRX cycle can be achieved and thereby the power saving requirements of UE can be satisfied. In addition, such a dynamic and flexible reporting procedure can eliminate data buffering problems at the RAN.

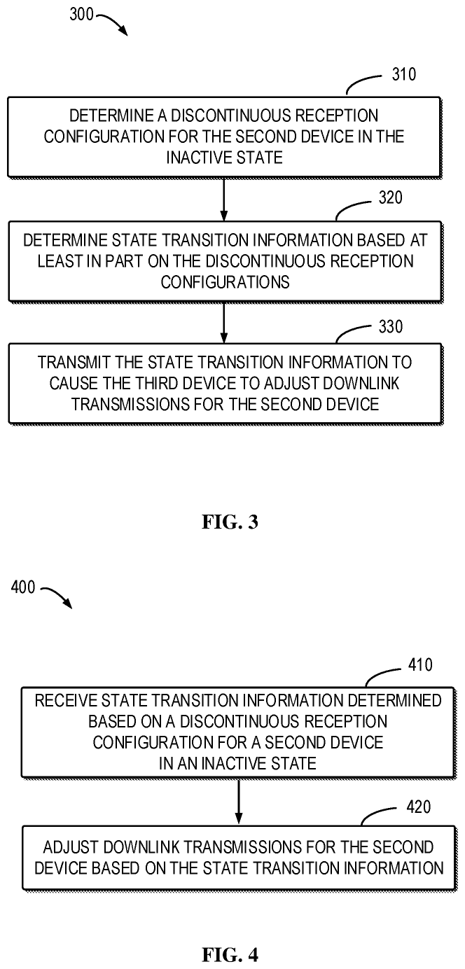

FIG. 3 shows a flowchart of an example method 300 according to some example embodiments of the present disclosure. The method 300 can be implemented at a device e.g., at the first device 110 as shown in FIG. 1. For the purpose of discussion, the method 300 will be described with reference to FIG. 1.

At 310, the first device 110 determines the eDRX configuration for the second device 120 in the inactive state. The second device 120 may be located within the RNA served by the first device 110 and the fourth device 140, namely, the coverage of the cells 102 and 104. The first device 110 may act as the anchor node of the RAN, and the fourth device 140 may act as the node that currently serves the second device 120 and maintains the context data of the second device 120.

In some example embodiments, the first device 110 may determine whether a state transition related to the inactive state (e.g., the RRC inactive state) is to be performed at the second device 120. The state transition related to the inactive state may include the first transition from a connected state to the inactive state or the second transition from the inactive state to the connected state. If the state transition related to the inactive state is to be performed at the second device 120, or alternatively, the second device 120 is in the eDRX mode, there may be a need for adjusting the DL transmissions to be forwarded to the second device 120 through the first device 110.

At 320, the first device 110 determines the configuration information based at least in part on the eDRX configuration. In some example embodiments, the configuration information may include at least one of a duration of eDRX cycle for the second device 120, the PTW of the second device 120, the PH number of the second device 120, the SFN associated with the first device 110, the buffer status of the first device 110, DL transmission occasions for the third device 130, the delay duration for the DL transmissions and so on.

In some example embodiments, the eDRX configuration determined in 310 may include a duration of the eDRX cycle for the second device 120. In these embodiments, the first device 110 may determine whether the duration of the eDRX cycle exceeds a duration threshold, for example, a preconfigured duration threshold or a configurable parameter configured by a mobile network operator. If the first device 110 determines that the duration of the eDRX cycle exceeds the duration threshold, it may indicate that the second device 120 may not frequently receive DL transmissions. Additionally or alternatively, it may undesirable for the first device 110 to buffer too many DL transmissions to be forwarded to the second device 120. In this case, the first device 110 may determine the configuration information based on the duration of the eDRX cycle, at 320.

Otherwise, if the duration of the eDRX cycle does not exceed the duration threshold, it may indicate that there is no need to inform the third device 130 of the state transition related to the inactive state. In this case, the first device 110 may not determine and transmit the configuration information to the third device 130.

In some example embodiments, in 320, the first device 110 may determine the configuration information based on the eDRX configuration and the duration of the retransmission timer of the third device 130. For example, the eDRX configuration determined in 310 may include a duration of the eDRX cycle for the second device 120. In these embodiments, the first device may determine whether a next paging occasion of the eDRX cycle arrives after the retransmission timer of the third device 130 expires. If the first device 110 determine that the next paging occasion of the eDRX cycle arrives after the retransmission timer expires, the first device 110 may determine the configuration information at 320.

In some example embodiments, in 320, the first device 110 may determine the configuration information based on the eDRX configuration and a buffer status of the first device 110. For example, the eDRX configuration determined in 310 may include a duration of the eDRX cycle for the second device 120. In these embodiments, the first device may determine whether the buffer of the first device 110 is to be filled with DL transmissions from the third device 130. If the first device 110 determines that the buffer of the first device 110 is to be filled with DL transmissions from the third device 130, the first device 110 may determine the configuration information at 320.

At 330, the first device 110 transmits, to the third device 130, the configuration information to cause the third device 130 to adjust the DL transmissions for the second device 120. In some example embodiments, the configuration information may be transmitted to the third device 130 via the RRC inactive transition report message.

The first device 110 may provide the third device 130 with additional information or indications for notifying the third device 130 when data transmissions for the second device 120 can be transmitted to the first device 110. In some example embodiments, the first device 110 may determine whether the duration of the eDRX cycle exceeds the duration threshold. If the duration of the eDRX cycle exceeds the duration threshold, the first device 110 may cause the third device 130 to increase the duration of the retransmission timer of the third device 130. For example, the first device 110 may transmit an indication of a possible retransmission delay or an increased duration of the retransmission timer, and thus the third device 130 may increase the duration of the retransmission timer based on such indication.

In some example embodiments, the first device 110 may determine whether the DL transmissions from the third device 130 are allowed based on the eDRX cycle of the second device 120. If the DL transmissions are allowed, the first device 110 may transmit, to the third device 130, a first indication of the DL transmissions being allowed. If the DL transmissions are not allowed, the first device 110 may transmit, to the third device 130, a second indication of no DL transmissions being allowed.

In some example embodiments, the UPF (not shown) may receive the uplink transmissions from the second device 120, which implicitly indicates that the DL transmissions are allowed. In this case, the first device 110, or alternatively the UPF may transmit a first indication of the DL transmissions being allowed to the third device 130.

In some example embodiments, upon the DL transmissions from the third device 130 arrive the first device 110, the first device 110 may reject the data forwarding or further data forwarding. For example, the first device 110 may drop the DL transmissions based on the buffer status of the first device 110. In addition, the first device 110 may transmit to the fourth device, an indication of the DL transmissions being dropped.

In some example embodiments, the first device 110 may receive the DL transmissions including at least one of a paging request, data transmissions or data retransmissions from the third device 130. In these embodiments, the third device 130 may transmit, to the second device 120, the DL transmissions based on the state transition.

In some example embodiments, the first device 110 may be the anchor node for the arca (e.g., the RNA), the second device 120 may be a terminal device, for example, a low-complexity UE moving within the RNA, and the third device 130 may be a CN node configured with the AMF.

In some example embodiments, the first device 110 may determine that the next PO for the second device 120 is so close that the retransmission timer would not expire before the next PO arrives. Alternatively, the first device 110 may determine that its buffer has enough free capacity. In the above cases, the first device 110 may determine not to transmit the configuration information or the additional information and indications to the third device 130. In the embodiments where any of the above situations changes, for example, the first device 110 may not receive any paging response from the second device 120, or the buffer status is changed, the first device 110 may determine whether to transmit the configuration information or the additional information and indications to the third device 130 again.

It should be understood that the configuration information as well as the additional information and indications as described in details above may be transmitted via a single signal or message, such as, the RRC inactive transition report message. It is also possible for such information and indications to be transmitted separately or part of the same may be transmitted via the RRC inactive transition report message while the rest part may be transmitted via another message or signal. The scope of the present disclosure is not limited in this regard.

FIG. 4 shows a flowchart of an example method 400 according to some example embodiments of the present disclosure. The method 400 can be implemented at a device e.g., at the third device 130 as shown in FIG. 1. For the purpose of discussion, the method 400 will be described with reference to FIG. 1.

At block 410, the third device 130 receives configuration information from the first device 110 of the RAN. In some example embodiments, the configuration information may be determined based on the eDRX configuration for the second device 120 in the inactive state. In these embodiments, the second device 120 is located within the area served by one or more devices comprising the first device 110. For example, the area may be the RNA corresponding to the coverage of cells 102 and 104.

In some example embodiments, the configuration information may be received from the first device 110 in the RRC inactive transition report message for indicating a state transition related to the inactive state performed at the second device 120. The state transition related to the inactive state may include one of the first transition from the connected state to the inactive state, or the second transition from the inactive state to the connected state. It should be understood that the RRC inactive transition report message is merely given as one of various implementations for transmission of the configuration information. It is also possible for transmission of the configuration information via any other suitable message or signal.

In some example embodiments, the configuration information may include at least one of a duration of eDRX cycle for the second device 120, the PTW of the second device 120, the PH number of the second device 120, the SFN associated with the first device 110, the buffer status of the first device 110, DL transmission occasions for the third device 130, the delay duration for the DL transmissions and so on.

At 420, the third device 130 adjusts the DL transmissions for the second device 120 based on the configuration information. In some example embodiments, the configuration information received at 410 may include the eDRX configuration for the second device. In these embodiments, at 420, the third device 130 may determine the reachability of the second device 120 based on the eDRX configuration. The third device 130 may then transmit the DL transmissions based on the reachability of the second device 120.

In some example embodiments, the configuration information received at 410 may include the DL transmission occasions for the third device 130. In these embodiments, as a result of adjustment at 420, the third device 130 may transmit the DL transmissions on the DL transmission occasions.

In some example embodiments, the configuration information received at 410 may include the buffer status of the first device 110. In these embodiments, at 420, the third device 130 may determine the buffer size of the first device 110 based on the buffer status. In addition, as a result of adjustment at 420, the third device 130 may transmit the DL transmissions of a first size below the buffer size.

The third device 130 may receive additional information or indications from the first device 110 for notifying the third device 130 when data transmissions for the second device 120 can be transmitted to the first device 110. In some example embodiments, the third device 130 may receive an indication from the first device 110, and the indication may indicate increasing a duration of a retransmission timer of the third device 130.

In some example embodiments, the third device 130 may receive, from the first device 110, one of the first indication of the DL transmissions being allowed and the second indication of no downlink transmission being allowed.

In a case where the third device 130 receives the second indication or alternatively, the third device 130 determines no DL transmission is allowed based on the configuration information and the additional information or indications received from the first device 110, the third device 130 may reject all the paging requests that happen during the period of time the second device 120 does not accept paging requests and data transmissions.

In some example embodiments, the third device 130 may transmit, to the first device 110, the DL transmissions to be forwarded to the second device 120. If the first device 110 drops the DL transmissions, the third device 130 may then receive, from the first device 110, an indication of the DL transmissions being dropped.

In some example embodiments, the first device 110 may be the anchor node for the area (e.g., the RNA), the second device 120 may be a terminal device, for example, a low-complexity UE moving within the RNA, and the third device 130 may be a CN node configured with the AMF.

It should be understood that the configuration information as well as the additional information and indications as described in details above may be received via a single signal or message, such as, the RRC inactive transition report message. It is also possible for such information and indications to be received in separate messages or signals, or alternatively, a part of the same may be received via the RRC inactive transition report message while the rest part may be received via one or more other messages or signals. The scope of the present disclosure is not limited in this regard.

The example embodiments of the present disclosure provide a flexible state transition reporting procedure. Once the state transition related to the RRC inactive state is determined to be performed, the RAN node, for example, the anchor gNB of the RNA can inform the AMF of the CN of this fact in a dynamic and flexible manner. As such, the AMF can adjust the paging procedure and data transmissions to be forwarded to the UE by taking the eDRX configurations and the buffer state of the RAN node into consideration.

In some example embodiments, a first apparatus capable of performing the method 300 may comprise means for performing the respective steps of the method 300. The means may be implemented in any suitable form. For example, the means may be implemented in a circuitry or software module.

In some example embodiments, the first apparatus comprises: means for determining, at a first apparatus, an extended discontinuous reception configuration for a second apparatus in an inactive state, the second apparatus located within an arca served by one or more devices comprising the first apparatus; means for determining configuration information based at least in part on the extended discontinuous reception configuration; and means for means for transmitting, to a third apparatus of a core network, the configuration information to cause the third apparatus to adjust downlink transmissions for the second apparatus.

In some example embodiments, the means for determining the configuration information comprises: means for in accordance with a determination that the second apparatus is in an extended discontinuous reception mode or to perform a state transition related to the inactive state, determining the configuration information, the state transition related to the inactive state comprises one of a first transition from a connected state to the inactive state, or a second transition from the inactive state to the connected state.

In some example embodiments, the configuration information is transmitted to the third apparatus via a radio resource control inactive transition report message.

In some example embodiments, the configuration information comprises at least one of: a duration of an extended discontinuous reception cycle for the second apparatus, a paging transmission window of the second apparatus, a paging hyperframe number of the second apparatus, a system frame number associated with the first apparatus, a buffer status of the first apparatus, downlink transmission occasions for the third apparatus, or a delay duration for the downlink transmissions.

In some example embodiments, the extended discontinuous reception configuration comprises a duration of an extended discontinuous reception cycle for the second apparatus, and the means for determining the configuration information comprises: means for in accordance with a determination that the duration of the extended discontinuous reception cycle exceeds a duration threshold, determining the configuration information based on the duration of the extended discontinuous reception cycle.

In some example embodiments, the means for determining the configuration information comprises: means for determining the configuration information based on the extended discontinuous reception configuration and a duration of a retransmission timer of the third apparatus.

In some example embodiments, the extended discontinuous reception configuration comprises a duration of an extended discontinuous reception cycle for the second apparatus, and the means for determining the configuration information comprises: means for in accordance with a determination that the buffer of the first apparatus is to be filled with downlink transmissions from the third apparatus, determining the configuration information.

In some example embodiments, the first apparatus further comprises: means for in accordance with a determination that a duration of the extended discontinuous reception cycle exceeds a duration threshold, causing the third apparatus to increase a duration of a retransmission timer of the third apparatus.

In some example embodiments, the first apparatus further comprises: means for determining whether the downlink transmissions are allowed based on the extended discontinuous reception cycle of the second apparatus; means for in accordance with a determination that the downlink transmissions are allowed, transmitting, to the third apparatus, a first indication of the downlink transmissions being allowed; and means for in accordance with a determination that the downlink transmissions are not allowed, transmitting, to the third apparatus, a second indication of no downlink transmission being allowed.

In some example embodiments, the first apparatus further comprises: means for in response to receiving uplink transmissions from the second apparatus, determining that the downlink transmissions are allowed; and means for transmitting, to the third apparatus, a first indication of the downlink transmissions being allowed.

In some example embodiments, the first apparatus further comprises: means for dropping the downlink transmissions from the third apparatus based on a buffer status of the first apparatus; and means for transmitting, to the third apparatus, an indication of the downlink transmissions being dropped.

In some example embodiments, the first apparatus further comprises: means for receiving, from the third apparatus, the downlink transmissions comprising at least one of a paging request, data transmissions or data retransmissions; and means for transmitting, to the second apparatus, the downlink transmissions.

In some example embodiments, the first apparatus comprises an anchor node for the area, the second apparatus comprises a terminal device, and the third apparatus comprises a network device configured with an access and mobility management function.

In some example embodiments, a second apparatus capable of performing the method 400 may comprise means for performing the respective steps of the method 400. The means may be implemented in any suitable form. For example, the means may be implemented in a circuitry or software module.

In some example embodiments, the second apparatus comprises: means for receiving, at a third apparatus and from a first apparatus of an access network, configuration information, the configuration information determined based on an extended discontinuous reception configuration for a second apparatus in an inactive state, and the second apparatus located within an area served by one or more devices comprising the first apparatus; and means for adjusting downlink transmissions for the second apparatus based on the configuration information.

In some example embodiments, the configuration information is received from the first apparatus in a radio resource control inactive transition report message for indicating a state transition related to the inactive state performed at the second device, the state transition related to the inactive state comprising one of a first transition from a connected state to the inactive state, or a second transition from the inactive state to the connected state.

In some example embodiments, the configuration information comprises at least one of: a duration of an extended discontinuous reception cycle for the second apparatus, a paging transmission window of the second apparatus, a paging hyperframe number of the second apparatus, a system frame number associated with the first apparatus, a buffer status of the first apparatus, downlink transmission occasions for the third apparatus, or a delay duration for the downlink transmissions.

In some example embodiments, the configuration information comprises the extended discontinuous reception configuration for the second apparatus, and the means for adjusting the downlink transmissions comprises: means for determining a reachability of the second apparatus based on the extended discontinuous reception configuration; and means for transmitting the downlink transmissions based on the reachability of the second apparatus.

In some example embodiments, the configuration information comprises downlink transmission occasions for the third apparatus, and the means for adjusting the downlink transmissions comprises: means for transmitting the downlink transmissions on the downlink transmission occasions.

In some example embodiments, the configuration information comprises a buffer status of the first apparatus, and the means for adjusting the downlink transmissions comprises: means for determining a buffer size of the first apparatus based on the buffer status; and means for transmitting the downlink transmissions of a first size below the buffer size.

In some example embodiments, the second apparatus further comprises: means for receiving, from the first apparatus, an indication of increasing a duration of a retransmission timer of the third apparatus.

In some example embodiments, the second apparatus further comprises: means for receiving, from the first apparatus, a first indication of the downlink transmissions being allowed; and means for receiving, from the first apparatus, a second indication of no downlink transmission being allowed.

In some example embodiments, the second apparatus further comprises: means for transmitting, to the first apparatus, the downlink transmissions; and means for receiving, from the first apparatus, an indication of the downlink transmissions being dropped.

In some example embodiments, the first apparatus comprises an anchor node for the area, the second apparatus comprises a terminal device, and the third apparatus comprises a network device configured with an access and mobility management function.

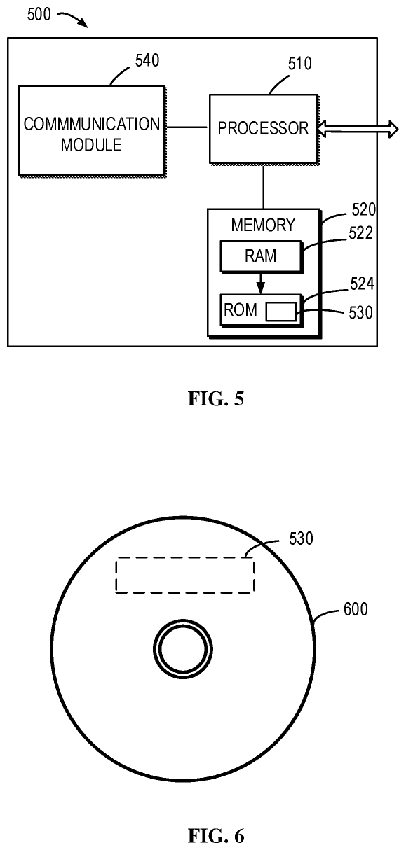

FIG. 5 is a simplified block diagram of a device 500 that is suitable for implementing embodiments of the present disclosure. The device 500 may be provided to implement the communication device, for example the first device 110, the second device 120, the third device 130 and the fourth device 140, as shown in FIG. 1. As shown, the device 500 includes one or more processors 510, one or more memories 520 coupled to the processor 510, and one or more communication modules 540 coupled to the processor 510.

The communication module 540 is for bidirectional communications. The communication module 540 has at least one antenna to facilitate communication. The communication interface may represent any interface that is necessary for communication with other network elements.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The program 530 may be stored in the ROM 520. The processor 510 may perform any suitable actions and processing by loading the program 530 into the RAM 520.

The embodiments of the present disclosure may be implemented by means of the program 530 so that the device 500 may perform any process of the disclosure as discussed with reference to FIGS. 3 and 4. The embodiments of the present disclosure may also be implemented by hardware or by a combination of software and hardware.

In some embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. The computer readable medium may include any types of tangible non-volatile storage, such as ROM, EPROM, a flash memory, a hard disk, CD, DVD, and the like. FIG. 6 shows an example of the computer readable medium 600 in form of CD or DVD. The computer readable medium has the program 530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 300 or 400 as described above with reference to FIGS. 3-4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an crasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device, comprising:
at least one processor; and
at least one memory including computer program code;
wherein the at least one memory and the computer program code are configured to, with the at least one processor, cause the first device at least to:
determine an extended discontinuous reception configuration for a second device in an inactive state, the second device located within an area served by one or more devices comprising the first device;
determine configuration information based at least in part on the extended discontinuous reception configuration; and
transmit, to a third device of a core network, the configuration information to cause the third device to adjust downlink transmissions for the second device.

2. The first device of claim 1, wherein the first device is caused to determine the configuration information by:
in accordance with a determination that the second device is in an extended discontinuous reception mode or to perform a state transition related to the inactive state, determining the configuration information, the state transition related to the inactive state comprising one of:
a first transition from a connected state to the inactive state, or
a second transition from the inactive state to the connected state.

3. The first device of claim 1, wherein the configuration information is transmitted to the third device via a radio resource control inactive transition report message.

4.-5. (canceled)

6. The first device of claim 1, wherein the first device is caused to determine the configuration information by:
determining the configuration information based on the extended discontinuous reception configuration and a duration of a retransmission timer of the third device.

7. The first device of claim 6, wherein the extended discontinuous reception configuration comprises a duration of an extended discontinuous reception cycle for the second device, and the first device is caused to determine the configuration information by:
in accordance with a determination that a next paging occasion of the extended discontinuous reception cycle arrives after the retransmission timer of the third device expires, determining the configuration information.

8.-15. (canceled)

16. A third device, comprising:
at least one processor; and
at least one memory including computer program code;
wherein the at least one memory and the computer program code are configured to, with the at least one processor, cause the third device at least to:
receive, from a first device of an access network, configuration information, the configuration information determined based on an extended discontinuous reception configuration for a second device in an inactive state, and the second device located within an area served by one or more devices comprising the first device; and
adjust downlink transmissions for the second device based on the configuration information.

17. The third device of claim 16, wherein the configuration information is received from the first device in a radio resource control inactive transition report message for indicating a state transition related to the inactive state performed at the second device, the state transition related to the inactive state comprising one of:
a first transition from a connected state to the inactive state, or
a second transition from the inactive state to the connected state.

18. The third device of claim 16, wherein the configuration information comprises at least one of:
a duration of an extended discontinuous reception cycle for the second device,
a paging transmission window of the second device,
a paging hyperframe number of the second device,
a system frame number associated with the first device,
a buffer status of the first device,
downlink transmission occasions for the third device, or
a delay duration for the downlink transmissions.

19. The third device of claim 16, wherein the configuration information comprises the extended discontinuous reception configuration for the second device, and the third device is caused to adjust the downlink transmissions by:
determining a reachability of the second device based on the extended discontinuous reception configuration; and
transmitting the downlink transmissions based on the reachability of the second device.

20. The third device of claim 16, wherein the configuration information comprises downlink transmission occasions for the third device, and the third device is caused to adjust the downlink transmissions by:
transmitting the downlink transmissions on the downlink transmission occasions.

21. The third device of claim 16, wherein the configuration information comprises a buffer status of the first device, and the third device is caused to adjust the downlink transmissions by:
determining a buffer size of the first device based on the buffer status; and
transmitting the downlink transmissions of a first size below the buffer size.

22. The third device of claim 16, wherein the third device is further caused to:
receive, from the first device, an indication of increasing a duration of a retransmission timer of the third device.

23. The third device of claim 16, wherein the third device is further caused to:
receive, from the first device, a first indication of the downlink transmissions being allowed; or
receive, from the first device, a second indication of no downlink transmission being allowed.

24. The third device of claim 16, wherein the third device is further caused to:
transmit, to the first device, the downlink transmissions; and
receive, from the first device, an indication of the downlink transmissions being dropped.

25. The third device of claim 16, wherein the first device comprises an anchor node for the area, the second device comprises a terminal device, and the third device comprises a network device configured with an access and mobility management function.

26. A method comprising:
determining, at a first device, an extended discontinuous reception configuration for a second device in an inactive state, the second device located within an area served by one or more devices comprising the first device;
determining configuration information based at least in part on the extended discontinuous reception configuration; and
transmitting, to a third device of a core network, the configuration information to cause the third device to adjust downlink transmissions for the second device.

27.-40. (canceled)

41. A method comprising:
receiving, at a third device and from a first device of an access network, configuration information, the configuration information determined based on an extended discontinuous reception configuration for a second device in an inactive state, and the second device located within an area served by one or more devices comprising the first device; and
adjusting downlink transmissions for the second device based on the configuration information.

42.-44. (canceled)

45. The method of claim 41, wherein the configuration information comprises downlink transmission occasions for the third device, and wherein adjusting the downlink transmissions comprises:
transmitting the downlink transmissions on the downlink transmission occasions.

46.-54. (canceled)
